(19) United States
(12) Patent Application Publication
(10) Pub. No.: US 2006/0124777 A1
(43) Pub. Date: Jun. 15, 2006

(54) Vacuum generating device, particularly for operating actuator members in fluid delivery systems

(76) Inventor: Arno Drechsel, Bolzano (IT)

Correspondence Address: Serafini Associates, 7660 FAY AVE. STE H378, LA JOLLA, CA, 92037, US

(21) Appl. No.: 10/560,286

(22) PCT Filed: Jun. 11, 2004
(86) PCT No.: PCT/IB04/01948

§ 371 Date: Dec. 13, 2005

(30) Foreign Application Priority Data
Jun. 13, 2003 (IT) VI2003A000115

(51) Int. Cl. B05B 7/30; F23D 11/16; A62C 31/02

(52) U.S. Cl. 239/589; 239/419.5; 239/354

(57) ABSTRACT

A vacuum generating device, particularly for operating actuator members in fluid delivery systems, comprises a duct (3) for a main pressurized fluid which extends along a longitudinal axis (L). The longitudinal duct (3) has an inlet portion (4), an outlet portion (5) and a restrictedportion (6) interposed therebetween, which is adapted to generate a venturi-induced negative pressure. The device (1) further includes a first radial conduit (7) in fluid communication with the restrictedportion (6) and with the outside, and at least one second radial conduit (9), which is also in fluid communication with the restrctedportion (6) and with the outside

### FIELD OF THE INVENTION

The present invention generally finds application in the field of irrigation and liquid dispensing systems, and particularly relates to an operating device as described in the preamble of claim 1.

### BACKGROUND OF THE INVENTION

A number of operating devices are known, which are used in irrigation systems having one or more liquid jets, for appropriately driving the latter. Typically, such operating devices use the energy of the liquid to be delivered to provide jet motion.

Particularly, either a rotary motion may be produced by small-sized hydraulic turbines or a reciprocating translational motion may be produced by a combination of pistons and elastic members.

By way of example, U.S. Pat. No. 4,681,259 discloses a rotary drive sprinkler wherein, during operation, the water to be sprayed sets a piston into reciprocating motion. This latter is coupled to a motion converter which rotates the outlet stem of the sprinkler in steps of a predetermined width.

An apparent drawback of this type of devices that are operated by the liquid to be delivered is that they may be easily clogged or obstructed so that their operation may be thus impaired. The liquid often contains impurities and may also include solid particles or foreign bodies of various sizes, such as minerals, sand, algae. The impurities in water may build up in particular areas of these devices, and reduce liquid flow or produce an irregular motion, thereby decreasing the reliability of the device and increasing the maintenance costs therefor.

Operating devices are further known which are used to control liquid delivery in irrigation systems, and include a Venturi device capable of generating an appropriate negative pressure.

Particularly, U.S. Pat. No. 4,900,189 discloses an operating device for pulsed and automatic delivery of an irrigation liquid, which includes a Venturi device fed with the irrigation liquid. The device comprises a liquid inlet duct, a liquid outlet duct and an auxiliary duct having an end at the restricted section of the Venturi device. By this arrangement, the auxiliary duct transmits the negative pressure generated by the Venturi device to a sliding piston, which is capable of reciprocating and of selectively preventing the passage of liquid from the inlet duct to the outlet duct, as well as of selectively opening a vent to the atmosphere.

During operation, when the liquid passes from the inlet duct to the outlet duct, the negative pressure generated by the Venturi device keeps the piston in a first position liquid wherein the fluid passage is open and the vent is closed. As pressure increases upstream from the operating device and the flow is accordingly reduced, the pressure in the auxiliary duct also increases until it causes the piston to move to a second position in which liquid flow is stopped and atmospheric pressure is introduced in the auxiliary duct. The abrupt pressure drop in the auxiliary duct brings the piston back to the first position and a new pulsed cycle is initiated.

A drawback of this solution is that the piston may be only displaced upon a change of the conditions of the liquid upstream of the operating device, and an operator cannot operate the piston directly by a manual or remote control. Furthermore, the sequence of piston movements is rigidly determined by the geometric design of the control device and by the characteristics of the irrigation system upstream from the device. Particularly, the sequence of movements may not be changed as desired, to fit different applications.

### DISCLOSURE OF THE INVENTION

A general object of this invention is to obviate the above drawbacks, by providing a cost-effective operating device.

A primary object is to provide a device having a safe and reliable operation, and whose features remain unchanged with time.

A particular object is to provide a device whose operating sequence may be easily controlled and changed.

A further object of the invention is to provide a device that may controlled by a directly or remotely connected computer, according to a desired program.

Another particular object is to provide a device that can change the motion characteristics of the delivered fluid, particularly allowing the transition from laminar flow into turbulent flow and vice versa.

A further particular object is to provide a device that requires little maintenance and is easily cleanable.

These objects, as well as other objects that will be more apparent hereinafter, are achieved, according to claim 1, by a vacuum generating device, particularly for operating actuator members in fluid delivery systems, which comprises a passageway for a main pressurized fluid, extending along a longitudinal axis, the longitudinal passageway having an inlet portion, an outlet portion and a restricted portion located therebetween, and adapted to generate a vacuum by Venturi effect, a first radial conduit in fluid communication with the restricted portion and with the outside, characterized in that it comprises at least one second radial conduit, which is also in fluid communication with the restricted portion and with the outside.

Thanks to this particular arrangement, one or more actuator members may be operated by depressurized air, without directly using the main pressurized fluid, which may contain impurities, like the liquid that is used for irrigation purposes. This provides a safe and reliable operation, and dramatically reduces the malfunctioning caused by the build-up of obstructions, particularly along the path of the main pressurized fluid.

Preferably, the device may include means for closing the passage of the second radial conduit, which are adapted to change the size of the passage and/or to selectively close it off.

This allows to control the negative pressure that is used to operate the actuator members and, at the same time, to change the motion conditions of the main pressurized fluid flow. This feature will particularly allow to change the pressurized fluid motion from laminar flow to turbulent flow and vice versa.

Suitably, the closing means may include a valve that is electrically controlled by a control unit.

This allows to easily control the actuator members, for instance according to a desired program and by using a directly or remotely connected computer.

### BRIEF DESCRIPTION OF THE DRAWINGS

Further features and advantages of the invention will be more apparent from the detailed description of several preferred but non-exclusive embodiments of a vacuum generating device and an assembly according to the invention, which are described by way of non-limiting examples with the help of the annexed drawings, in which:

FIG. 1 is a sectional side view of a device according to the invention;

FIG. 2 is a sectional perspective view of the device of FIG. 1;

FIG. 3 is an exploded perspective view of the device of FIG. 1;

FIG. 4 is a sectional perspective view of an assembly according to the invention;

FIG. 5 is a schematic view of an embodiment of an assembly according to the invention;

FIG. 6 is a schematic view of a further embodiment of an assembly according to the invention.

### DETAILED DESCRIPTION OF A PREFERRED EMBODIMENT

With particular reference to the above figures, a vacuum generating device according to the invention is described, which is generally designated with numeral 1. Device 1 may be used in various applications, and is particularly advantageous for operating one or more movable actuators 2 in fluid delivery systems, e.g. irrigation systems.

The device 1 includes a duct 3 extending along a longitudinal axis L, for the passage of a main pressurized fluid, possibly a liquid, e.g. the same liquid to be later used for irrigation, or a different fluid, e.g. compressed air.

Duct 3 has an inlet portion 4, an outlet portion 5 and a restricted portion 6 located therebetween, for generating a vacuum by Venturi effect. The inner diameters D_{I}, D_{R}, D_{U} of the inlet 4, restricted 6 and outlet 5 portions may have respective different values. Particularly, the diameter D_{R} of the restricted portion 6 is smaller than the diameter D_{I} of the inlet portion 4, to generate the desired vacuum and may be even smaller than the diameter D_{U} of the outlet portion 5. The latter diameter may further be slightly smaller than the diameter D_{I} of the inlet portion 4.

Device 1 also comprises a first radial conduit 7 in fluid communication with the restricted portion 6 and with the outside. In one particular embodiment, the first radial conduit 7 may have at least one connecting port 8 for transmitting the negative pressure to one or more actuator members 2.

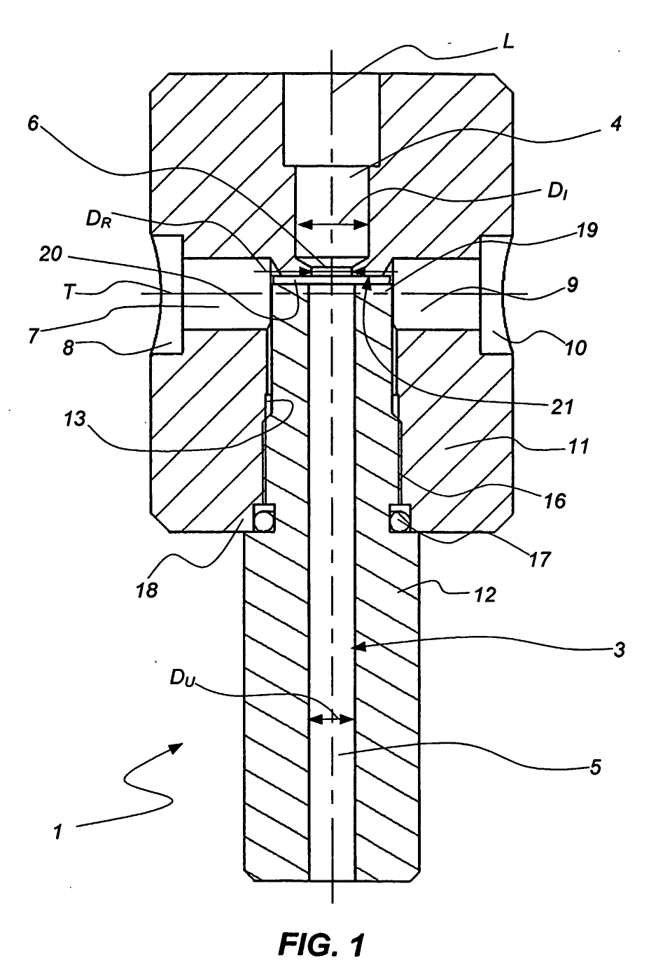

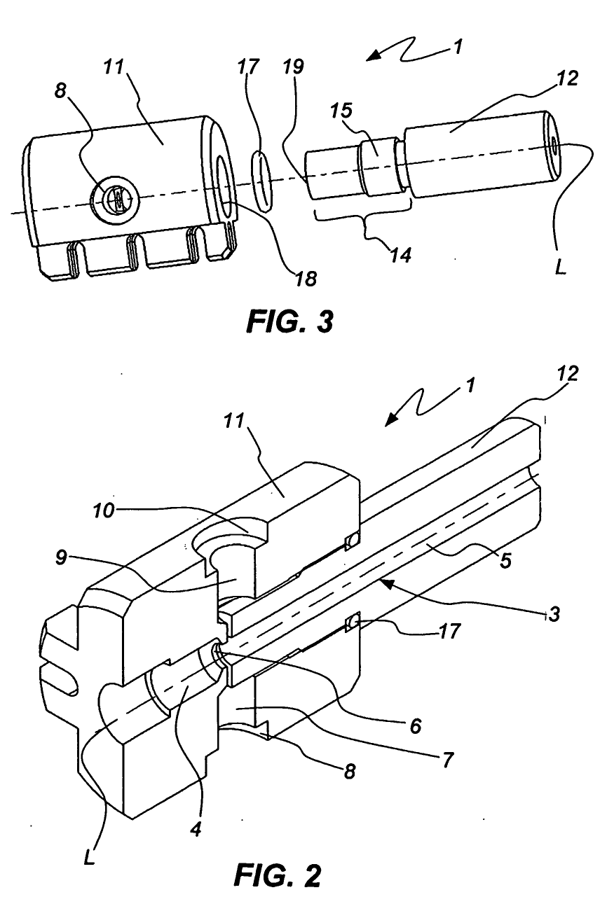

In accordance with the invention, device 1 comprises at least one second radial conduit 9, which is also in fluid communication with the restricted portion 6 and with the outside. In the embodiment as shown in FIGS. 1-3, the second radial conduit 9 may have an orifice 10 communicating with the outside environment at atmospheric pressure.

Thanks to this arrangement, by appropriately adjusting the size of the orifice 10, air pressure may be controlled in the second radial conduit 9, and, as a result, also in the first radial conduit 7, as both conduits 7, 9 communicate with the restricted portion 6.

Also, when the orifice 10 is open, the vacuum generated at the restricted portion 6 causes ambient air to be drawn in, and at least a part of it to be admitted into the outlet portion 5, wherein it mixes with the main fluid flowing through duct 3. Therefore, by adjusting the size of the orifice 10, the motion type of the main fluid flow in the outlet portion 5 may be also changed, particularly by inducing in the fluid a transition from laminar motion to turbulent motion or vice versa.

This additional operation on the main pressurized fluid is particularly useful when the device 1 is used in an irrigation system. In fact, by introducing air into the irrigation liquid flow, the liquid jet may be easily and controllably broken up, to obtain the desired dispersion thereof, without using special external mechanisms.

Suitably, the inlet portion 4 is formed within a main body 11, and the outlet portion 5 is formed within a tubular member 12. Furthermore, the main body 11 and the tubular member 12 may be mutually coupled so that the inlet 4, outlet 5 and restricted 6 portions are aligned along the longitudinal axis L. The alignment thereof along the same longitudinal axis L allows to minimize localized fluid energy losses.

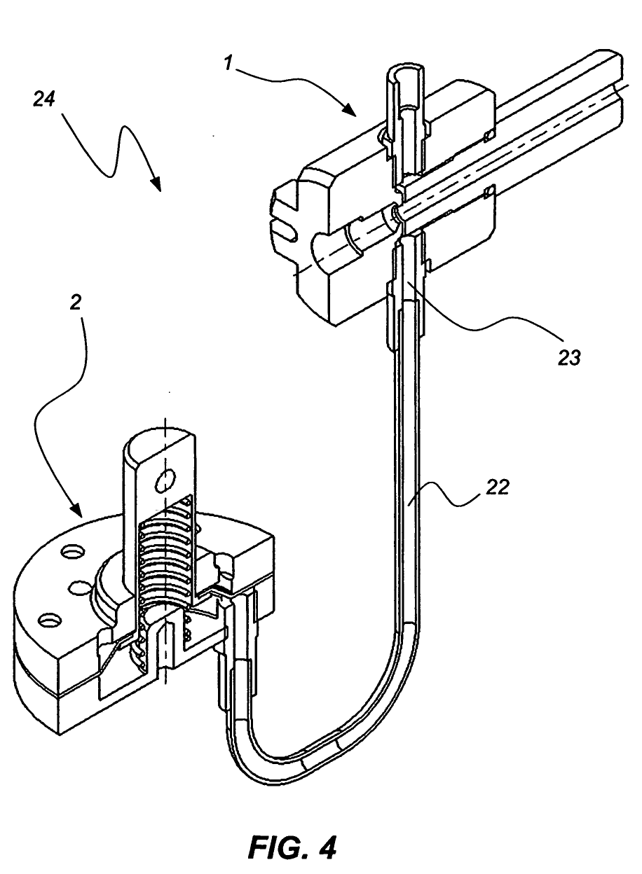

The main body 11 may further include a hollow seat 13 for a connecting portion 14 of the tubular member 12. The interconnection between the connecting portion 14 and the hollow seat 13 is effected by appropriate coupling means. As seen in greater detail in a particular embodiment which is shown in FIGS. 1-4, the connecting portion 14 of the tubular member 12 may have external threads 15 for engagement in corresponding internal threads 16 on the hollow seat 13 of the main body 11.

A sealing ring 17 is further provided between the main body 11 and the tubular member 12. Suitably, the sealing ring 17 may be positioned at a peripheral edge 18 of the hollow seat 13, to prevent ambient air from being drawn in between the connecting portion 14 and the hollow housing 13, thereby reducing the vacuum pressure transmitted to the first and second radial conduits 7, 9.

The latter may be formed within the main body 11 and extend substantially along a common geometric plane, orthogonal to the longitudinal axis L.

In greater detail, the first and second radial conduits 7, 9, may be advantageously disposed along the same transverse axis T, on opposite sides of the longitudinal axis L. Thus, a part of the air drawn in through the orifice 10 is admitted into the outlet portion 5, and mixes with the main pressurized fluid, and another part is transported toward the second radial conduit 9, and induces a pressure change therein.

Advantageously, a longitudinal end 19 of the connecting portion 14 may be positioned at a relatively small axial distance from the restricted portion 6 to receive the main pressurized fluid therefrom. Once the main pressurized fluid flow has passed through the restricted portion 6, it tends to progressively spread out transversely. Hence, the axial distance is selected to be relatively small so that substantially the whole main pressurized fluid flow which passes through the restricted portion 6 reaches the outlet portion 5 and spreads out until it adheres against the inner wall thereof.

Device 1 may have a central chamber 20 to put the first and the second radial conduits 7, 9 in fluid communication with each other and with the restricted portion 6. Particularly, the central chamber 20 may be an annular space between the longitudinal end 19 of the connecting portion 14 and the bottom surface 21 of the hollow housing 13.

Device 1 may include means (not shown) for closing the orifice 10 of the second radial conduit 9, in such a manner as to change the size of the orifice and/or to selectively close it off. In a particular embodiment, the closing means may include a valve that is electrically controlled by a control unit.

The vacuum generated in the restricted portion 6 may be transmitted to the actuator members 2 by respective connecting lines 22. Also, device 1 may include attachment means 23 for securing connecting line 22, which are positioned at the connecting port 8 of the first radial conduit 7.

In a further embodiment shown in FIG. 6 device 1 may comprise a plurality of radial conduits 7′, 7″, . . . in fluid communication with the restricted portion 6 and with the outside. Each of these radial conduits 7′, 7″, . . . , may be substantially like the first radial conduit 7 and angularly staggered with respect to it.

Furthermore, each radial conduit 7, 7′, 7″, . . . , may have at least one respective connecting port 8, 8′, 8″, . . . , for transmitting the vacuum generated at the restricted portion 6 to a plurality of external actuator members 2, 2′, 2″, . . . The plurality of radial conduits 7, 7′, 7″, . . . may be appropriately formed within the same main body 11, so that a number of external actuator members 2, 2′, 2″ may be operated by a single device 1, with the apparent advantage of reducing system's costs and complexity.

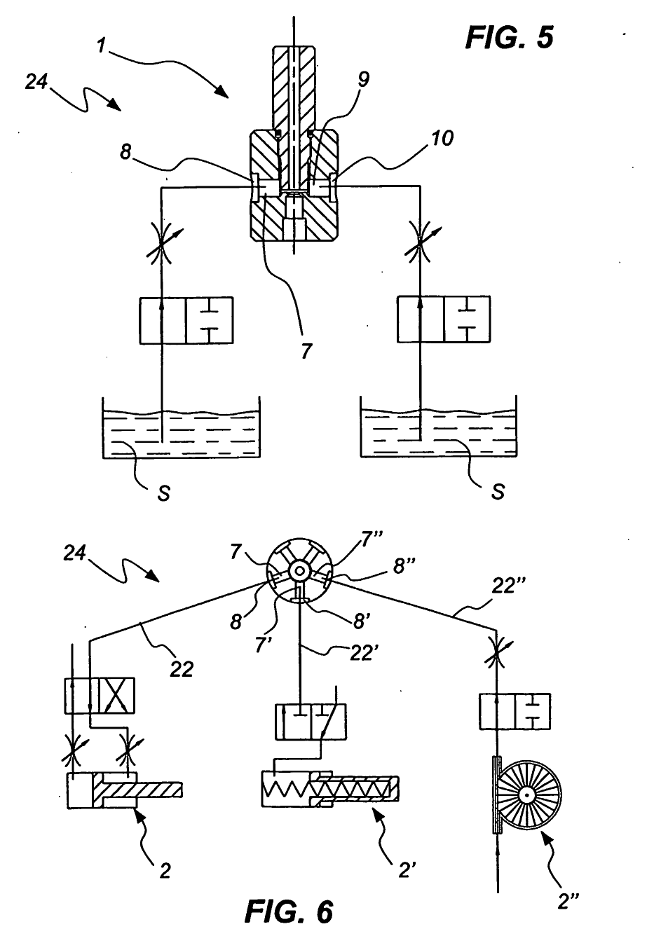

In yet another embodiment shown in FIG. 5, the first radial conduit 7 has at least one respective aperture 8 for allowing the passage of one or more secondary fluids, so that the latter are drawn in from one or more containers S, due to the vacuum generated at the restricted portion 6, and mix with the main fluid. Similarly, the second radial conduit 9 may also have an orifice 10 for allowing the passage of a secondary fluid. This embodiment of the device 1 may be advantageously used when one or more liquid or gaseous additives, e.g. fertilizing, anti-parasitic or other chemical agents, are to be mixed to the main fluid.

Moreover, when a plurality of radial conduits 7, 7′, 7″, . . . are provided, some of these may be connected to external actuator members 2, 2′, 2″, . . . , others may be used for drawing in and admitting a secondary fluid into the main fluid, and others may be selectively connected with the outside environment at ambient pressure by a respective valve.

In both embodiments of FIG. 5 and FIG. 6, the pressure and the flow of air or secondary fluid in each radial conduit 7, 9, 7′, 7″, . . . may be individually controlled, for each conduit, by valves or appropriate adjustment means.

At least one vacuum generating device according to the invention may be advantageously inserted in an assembly 24 for operating a fluid delivery system. Assembly 24 may further include at least one actuator member 2, 2′, 2″, . . . adapted to displace one or more movable elements (not shown) of the system by predetermined movements, and may be connected to the device 1 by a respective connecting line 22, 22′, 22″, . . .

As is apparent from the above disclosure, the device and assembly of the present invention fulfill the proposed objects, and particularly the use of the Venturi effect instead of the dynamic thrust of the pressurized fluid provides a safe and reliable operation. Furthermore, the provision of means for closing the orifice of the second radial passageway allows to easily adjust the negative pressure for operating the actuator elements.

The device and assembly of this invention are susceptible of a number of modifications and changes all falling within the scope of the appended claims. All the details thereof may be replaced by other technically equivalent parts, and the materials may vary depending on different needs, without departure from the scope of the invention.

While the device and assembly have been described with particular reference to the accompanying figures, the numerals referred to in the disclosure and claims are only used for the sake of a better intelligibility of the invention and shall not be intended to limit the claimed scope in any manner.

The instant application is based upon and claims priority of patent application no. VI2003A000115, filed on Jun. 13, 2003 in Italy, the disclosure of which is hereby expressly incorporated here in reference thereto.

What is claimed is:

1. A vacuum generating device, particularly for operating actuator members in fluid delivery systems, which device comprises a duct (3) extending along a longitudinal axis (L) for the passage of a main pressurized fluid, said longitudinal duct (3) having an inlet portion (4), an outlet portion (5) and a restricted portion (6) located therebetween and adapted to generate a vacuum by Venturi effect, a first radial conduit (7) in fluid communication with said restricted portion (6), at least one second radial conduit (9), in fluid communication with said restricted portion (6) and with the outside, characterized in that said first radial conduit (7) has at least one connecting port (8) for connecting with one or more external actuator members (2), a central chamber (20) being provided to put said first and said second radial conduits (7, 9) in fluid communication with each other and with said restricted portion (6).

2. Device as claimed in claim 1, characterized in that said second radial conduit (9) has an orifice (10) which is designed to change the pressure in said first (7) and said second (9) radial duct and also the flow conditions in said outlet portion (5).

3. Device as claimed in claim 2, characterized in that said orifice (10) is in fluid communication with the outside environment at atmospheric pressure.

4. Device as claimed in claim 3, characterized in that said inlet portion (4) is formed within a main body (11), and said outlet portion (5) is formed within a tubular member (12).

5. Device as claimed in claim 4, characterized in that said inner diameter (D_{R}) of the restricted portion (6) is smaller than the inside diameters (D_{I}, D_{U}) of the inlet portion (4) and the outlet portion (5) respectively, said main body (11) and said tubular member (12) being connected with each other so that said inlet (4), outlet (5) and restricted (6) portions are aligned along said longitudinal axis (L).

6. Device as claimed in claim 5, characterized in that said central body (11) comprises a hollow seat (13) which is adapted to house a connecting portion (14) of said tubular member (12).

7. Device as claimed in claim 6, characterized in that said connecting portion (14) of said tubular member (12) has external threads (15) for engagement in corresponding internal threads (16) on said hollow housing (13) of said main body (11).

8. Device as claimed in claim 6, characterized in that it comprises a sealing ring (17) between said main body (11) and said tubular member (12), which is positioned at a peripheral edge (18) of said hollow seat (13).

9. Device as claimed in claim 6, characterized in that said first and said second radial conduits (7, 9) are formed within said main body (11).

10. Device as claimed in claim 9, characterized in that said first and said second radial conduits (7, 9) substantially extend along a common geometrical plane, which is orthogonal to said longitudinal axis (L).

11. Device as claimed in claim 10, characterized in that said first and said second radial conduits (7, 9) are disposed along a common transverse axis (T), on opposite sides of said longitudinal axis (L).

12. Device as claimed in claim 9, characterized in that a longitudinal end (19) of the connecting portion (14) is positioned at a relatively small axial distance from said restricted portion (6) to receive the main pressurized fluid therefrom.

13. Device as claimed in claim 12, characterized in that said central chamber (20) is an annular space between the longitudinal end (19) of the connecting portion (14) of said tubular member (12) and the bottom surface (21) of said hollow seat (13) of said main body (11).

14. Device as claimed in claim 3, characterized in that it includes means for closing said orifice (10) of said second radial conduit (9), which are adapted to change the size of the orifice (10) and/or to selectively close it off.

15. Device as claimed in claim 14, characterized in that said closing means include a valve that is electrically controlled by a control unit.

16. Device as claimed in claim 2, characterized in that it comprises attachment means (23) for securing a connecting line (22) to one or more actuator members (2), said attachment means (23) being positioned at said connecting port (8) of said first radial conduit (7).

17. Device as claimed in claim 1, characterized in that it comprises a plurality of radial conduits (7′, 7″, . . . ) in fluid communication with said restricted portion (6) and with the outside, each radial conduit (7′, 7″, . . . ) of said plurality being substantially like said first radial conduit (7) and angularly staggered with respect to it.

18. Device as claimed in claim 17, characterized in that each radial conduit (7′, 7″, . . . ) of said plurality has at least one respective connecting port (8′, 8″, . . . ) for transmitting said negative pressure to a plurality of external actuator members (2′, 2″, . . . ), the pressure in each of said radial conduits (7′, 7″, . . . ) being controllable by a respective valve or appropriate adjustment means.

19. Device as claimed in claim 1, characterized in that said first (7) and/or said second (9) radial conduit have at least one respective suction port (8, 10) for the passage of one or more secondary fluids which are designed to be mixed with the main fluid at said restricted portion (6).

20. An assembly fort operating an irrigation system, comprising at least one actuator member (2, 2′, 2″, . . . ) adapted to displace one or more movable elements of said system by predetermined movements, characterized in that it comprises a vacuum generating device (1) according to one or more claims 1 to 19 connected to said actuator member (2, 2′, 2″, . . . ) by a respective connecting line (22, 22′, 22″, . . . ).
